(19) United States
(12) Patent Application Publication
(10) Pub. No.: US 2007/0214158 A1
(43) Pub. Date: Sep. 13, 2007

(54) Method and apparatus for conducting a robust search

(76) Inventor: Yakov Kamen, Cupertino, CA (US)

Correspondence Address: Yakov Kamen, 19334 Greenwood Drive, Cupertino, CA, 95014, US

(21) Appl. No.: 11/369,536

(22) Filed: Mar. 8, 2006

(51) Int. Cl. G06F 7/00

(52) U.S. Cl. 707/101

(57) ABSTRACT

A robust search system in accordance with the invention replaces a single search keyword with a cluster of similar keywords, applies a search procedure for each similar keyword independently, and aggregates results of multiple searches into a single result. In one embodiment of the invention separate clusters of similar keywords and a separate aggregation procedure are used for placement of contextual advertisements.

### CROSS-REFERENCE TO RELATED APPLICATIONS

This application claims the benefit of provisional patent YKP006SRH1-030505 filed 2005 Mar. 05 by the present inventor

### FEDERALLY SPONSORED RESEARCH

Not applicable

### SEQUENCE LISTING OF PROGRAM

Not applicable

### BACKGROUND OF THE INVENTION

This invention pertains to technology used for data search, particularly data search over the Internet.

In many cases search objects are described by using complex keywords consisting of multiple words or terms. For purposes hereof, such multiple word keywords are referred to as “long keywords.” Existing Internet search engines are optimized to handle short (one, two, three term) keywords and often generate very low quality search results for long keywords. Similar deficiencies exist with the semantic broad match placement of contextual advertisements (“ads”) related to long keyword searches: it is a known fact that the contextual ad placement accuracy degrades significantly when keywords consist of three or more terms.

I outline below three major problems related to the long keyword search and contextual ad placement for long keywords.

Monotonic search improvement problem. When a human user includes a new search term into an existing term sequence in an effort to improve results he/she is following Aristotle's principle of “monotonic improvement” which states effectively that the inclusion of additional relevant information will always increase the quality of reasoning. However, current search engine “logic” does not necessarily follow Aristotle's “monotonic improvement” principle unless the number of terms in a keyword search is fairly limited. Under current search engine logic, there is often a threshold number of terms a which point the search result relevance is maximized. When the number of terms in the keyword search surpasses that threshold number, search relevance starts to deteriorate. FIG. 1 illustrates such effect.

Semantic volatility problem. In many cases even “minimal” changes in keywords (i.e., replacing a term with its synonym, term permutation inside a keyword string, etc.) result in significant changes to the search result. In other words, semantically similar keywords may produce very different search results.

The above problems describe different aspects and/or deficiencies of the robustness of search engines.

The proposed invention defines a method and apparatus to improve search engine robustness and the effectiveness of contextual ad placement for long keyword searches.

### SUMMARY

The main idea of the invention is to replace a single search keyword with a group of “similar” search keywords (semantic keyword cluster), replace a single search with multiple searches and then aggregate the results using one of several [known] aggregation methods.

In one embodiment of the invention similar search keywords are generated from the originally submitted keyword by manipulating the original terms.

In one embodiment of the invention similar search keywords are generated by combining existing keyword terms and new terms.

In one embodiment of the invention similar search keywords are generated automatically by a specific predefined algorithm.

In one embodiment of the invention similar search keywords are generated using human interaction.

In one embodiment of the invention similar search keywords are combined together into complex “meta-keywords” which are presented as search criterion to a search engine.

In one embodiment of the invention multiple similar search keyword clusters are generated for search and for contextual advertisement (ads) placement.

In one embodiment of the invention weight coefficients will be assigned to each similar keyword in the cluster and a resulting aggregation will be provided using such weight coefficients.

### BRIEF DESCRIPTION OF THE DRAWINGS

FIG. 1—illustrates possible search relevance behavior as a function of the number of terms in keyword.

FIG. 2—shows a preferred embodiment system block diagram.

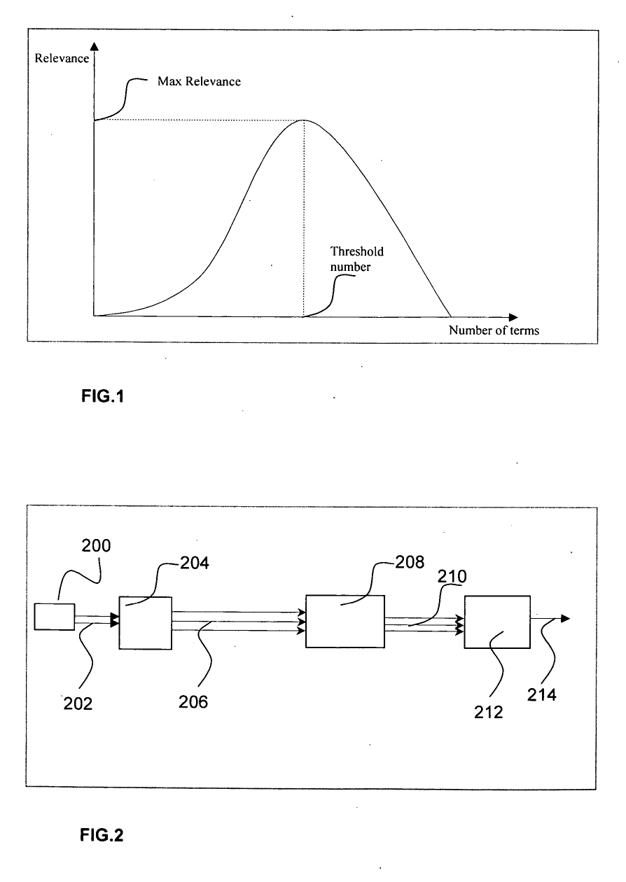

### DETAILED DESCRIPTION

This invention is related to FIG. 2 which describes the preferred embodiment of the invention. In FIG. 2, user 200 is performing a search using a keyword sequence that consists of multiple terms {a₁, a₂, . . . aₙ} as shown in 202. Block 204 generates a set of ordered term subsequences 206 {S₁(k₁) . . . Sⱼ(kⱼ), . . . } from the original sequence 202. Each term subsequence {Sⱼ(kⱼ)} is generated using a subset of terms from {a₁, a₂ . . . aₙ}.

For example, let's assume that user is searching for Friends Sitcom Episode 10.07 called “The One With The Home Study”. In our example search subsequences would be {(Friends, Sitcom), (Friends, Episode), (Friends, Episode, 10.7), (Friends, Sitcom, Episode), (Friends, Home), (Friends Study), (Friends Home Study)}.

Block 208 depicts a search engine accepting the term subsequences in 206 as a set of keywords and generating search results 210 for each keyword from 206. Block 212 aggregates the search results received for each keyword together into an “aggregated search result” 214.

### ADDITIONAL EMBODIMENTS

In one embodiment of the invention one or more terms in each term subsequence can be replaced by a term that did not exist in the original term set {a₁, a₂ . . . aₙ}.

For example, let's assume that user is searching for “James Bond, and he is using keyword “British Agent 007”. The patented method generates a new keyword that includes a combination of some terms from the ordinal set { British, Agent, 007} and new terms {James, Bond} to produce “James Bond Agent 007.”

In one embodiment of the invention keywords will be generated automatically by a special predefined procedure or algorithm.

In one embodiment of the invention keywords will be generated semi-automatically using user interaction.

In one embodiment of the invention block 204 generates combined terms meta-sequences using a subsequences “combination” operator.

For example, when a user is searching for Friends Sitcom Episode 10.07 called “The One With The Home Study” the keyword meta-sequence can be {(Friends, Sitcom) AND (Friends, Episode, 10.7)}.

In one embodiment of the invention block 204 generates special weight coefficients (or a “relevance score”) for each similar keyword in a keyword cluster

For example when a user is searching for Friends Sitcom Episode 10.07 called “The One With The Home Study” the search subsequences could be {(Friends, Sitcom), (Friends, Episode), (Friends, Episode, 10.7), (Friends, Sitcom, Episode), (Friends, Home), (Friends Study), (Friends Home Study)} and the associated relevance score or special weight coefficient list could be {70, 70, 82, 86, 31, 22, 97}.

In one embodiment of the invention block 208 uses more than one search engine to generate search matches and to generate contextual advertisements.

In one embodiment of the invention aggregation block 212 is simply merging search matches as follows r₁(1), r₂(1) . . . rₖ(1), r₁(2) . . . rₖ(2) . . . where rₖ(i) is i^{th} search match of the search result generated for subsequence Sₖ(.).

In one embodiment of the invention the aggregation algorithm defines and computes relevance criteria T for search matches and then orders those search matches based on criteria T. For instance, for each search match r its relevance criteria T(r) can be computed as T(r)=nᵢ(r)+ . . . +nₖ(r), where k is a number of used term subsequences, and nᵢ(r) is the r^{th} search match order of appearance in the i^{th} search result. The search matches in the aggregated search result are ordered according to their relevance criteria T(r). For instance, the search matches in the aggregated search result are put in the order r₁, r₂ . . . rₘ such that T(r₁)≦T(r₂) . . . ≦T(rₘ).

In one embodiment of the invention the search result depends on relevance coefficients assigned to each search match. The relevance criteria of a search match r can be computed as T(r)=v₁*n₁(r)+ . . . +vₖ*nₖ(r), where k is the number of used search subsequences, nᵢ(r) is the r^{th} search match order of appearance in the i^{th} search result and vᵢ is a weight coefficient for the i^{th} subsequence. The search matches in the aggregated search result are ordered according their relevance criteria T(r). For instance, the search matches in the aggregated search result are put in the order r₁, r₂ . . . rₘ such that T(r₁)≦T(r₂) . . . ≦T(rₘ).

In one embodiment of the invention contextual advertisements are considered separate entities. Separate keyword clusters are used to generate search matches and a corresponding contextual advertisement list. Separate aggregation blocks are used to generate a list of matches and a list of contextual advertisements.

In one embodiment of the invention the aggregation operator is a general averaging function. A function F(x₁ . . . xₙ) is called general average when min(x₁ . . . xₙ)≦F(x₁ . . . xₙ)≦max(x₁ . . . xₙ).

In one embodiment of the invention the keyword search sequence is filtered to remove insignificant “stop” words. Insignificant stop words could include the words “a”, “the”, “in”, “out”, “some”, “few”, “many”, etc.

Although the above description contains much specificity, the embodiments described above should not be construed as limiting the scope of the invention but rather as merely illustrations of some presently preferred embodiments of this invention.

1. A method of searching data comprising:
(i) generation of similar search keywords from an original search keyword and the criteria used to generate such similar search keywords; (ii) providing a separate search procedure for the original keyword and one or more similar keywords; (iii) providing separate contextual advertisement placement for the original keyword and one or more similar keywords; (iv) an aggregation procedure generation for integration of search results and the criteria for such aggregation procedure generation; and (v) an aggregation procedure for contextual advertisement integration and the criteria for such aggregation procedure generation.

2. The method of claim 1 wherein said similar keywords are generated using the original keyword's terms.

3. The method of claim 1 wherein said similar keywords are generated using the original keyword's terms and new terms.

4. The method of claim 1 wherein said similar keywords are generated using only new terms relevant to original terms.

5. The method of claim 1 wherein said similar keywords are generated by logical integration of other similar keywords.

6. The method of claim 1 wherein said similar keywords are generated automatically using a pre-defined similar keywords generation procedure.

7. The method of claim 1 wherein said similar keywords are generated with human interactions using a combination of pre-defined similar keywords generation and human ontology and experience.

8. The method of claim 1 wherein said search aggregation procedure uses matches ranks or rankings of derivatives as weighting coefficients.

9. The method of claim 1 wherein said contextual advertisement aggregation procedure uses an advertisement's price or price estimations and their derivatives as weighting coefficients.

10. The method of claim 1 wherein said similar keyword are generated from terms that do not belong to the special list of stop words and stop word queries.

11. The method of claim 6 wherein said automatic procedure uses term co-occurrence coefficients to choose similar keywords and their order.

12. The method of claim 6 wherein said automatic procedure uses term co-occurrence coefficients to choose similar keywords and their order

13. An apparatus comprising:
search keywords generation pipeline; and said search keywords generation pipeline similar keywords generation mean; and said search keywords generation pipeline search procedure mean; and said search keywords generation pipeline contextual advertisement placement mean; and said search keywords generation pipeline search procedure results aggregation mean; and said search keywords generation pipeline contextual advertisement placement aggregation mean.

14. The apparatus of claim 13 wherein said search procedure results aggregation mean includes the weight coefficients aggregation mean and the ranks aggregation mean.

15. The apparatus of claim 13 wherein said search keywords generation pipeline contextual advertisement placement aggregation mean includes the weight coefficients aggregation mean and the ranks aggregation mean.
